(19) United States
(12) Patent Application Publication
(10) Pub. No.: US 2023/0129466 A1
(43) Pub. Date: Apr. 27, 2023

(54) Identity intelligence in cloud-based services

(71) Applicant: Zscaler, Inc., San Jose, CA (US)

(72) Inventor: Scott Moore, Austin, TX (US)

(21) Appl. No.: 17/509,154

(22) Filed: Oct. 25, 2021

(51) Int. Cl. G06F 21/31; G06F 21/46; G06F 9/50; G06F 11/34

(52) U.S. Cl. CPC G06F 21/316; G06F 9/5072; G06F 11/3438; G06F 21/46; G06F 2221/2141

(57) ABSTRACT

The present disclosure relates to systems and methods for tying activity of a user or group in a cloud service with an identity provider (IDP). This intelligence from the cloud service can be used to continuously authenticate a user or group as they are using the cloud service, thus confirming authentication beyond the initial identity (ID) determination or login process. By gathering a baseline for the access of users and groups, it is possible to detect when a user or user device shows anomalous behavior. Responsive to detecting anomalous behavior, the IDP can be notified, and remediation can be quickly initiated with the utilization of security measures such as access denial, account disabling, requiring a user to change a password, and/or other actions of the like. Such security actions may be preset in a playbook built for response to various security risks.

### FIELD OF THE DISCLOSURE

The present disclosure generally relates to computer networking security and methods. More particularly, the present disclosure relates to systems and methods for tying activity in a cloud service with identity providers for enhanced security.

### BACKGROUND OF THE DISCLOSURE

Enterprises are using more and more applications as time progresses, and the Identity as a Service (IDaaS) market is seeing a transformation. Also, the enterprise network has changed as users are remote and the resources and applications are being hosted in the cloud. The traditional view of an enterprise network (i.e., corporate, private, etc.) included a well-defined perimeter defended by various appliances (e.g., firewalls, intrusion prevention, advanced threat detection, etc.). In this traditional view, mobile users utilize a Virtual Private Network (VPN), etc. and have their traffic backhauled into the well-defined perimeter. A user’s identity (ID) is currently determined via a plurality of attributes such as a username, password, department, phone number, and the like. This worked when mobile users represented a small fraction of the users, i.e., most users were within the well-defined perimeter. However, this is no longer the case - the definition of the workplace is no longer confined to within the well-defined perimeter, and with applications moving to the cloud, perimeter and identity determination has extended to the Internet. This results in an increased risk for the enterprise data residing on unsecured and unmanaged devices as well as the security risks in access to the Internet. Cloud-based security solutions have emerged, such as Zscaler Internet Access (ZIA) and Zscaler Private Access (ZPA), available from Zscaler, Inc., the applicant and assignee of the present application.

Once only well adopted by small and medium sized businesses, the Identity as a Service (IDaaS) market has attracted more interest. Many large businesses and enterprises are now quickly taking advantage of IDaaS due to low upfront investment, rapid deployment, simplified operation and native-integration with existing cloud workloads. This shift along with a landscape of upwardly-mobile consumers, remote workers, Bring your own device (BYOD) policies and a globally geo-dispersed workforce, has continued to stretch many organizations’ attack surfaces even wider than before. With this increased attack surface, security engineers are tasked with utilizing built-in anomalous detection capability from IDaaS vendors (Azure Security Center, Okta Anomaly Detection etc) or pay additional fees to implement. If misconfigured and tuned improperly, it is possible for threat actors to evade IDaaS detection controls altogether or for false-positives to appear. However, even when configured properly, there is a noticeable gap in latency of notification, contextual awareness and Signal-to-Noise ratio (SNR) of logs is often too low, noisy, and hard to decipher actionable signals without considerable indexing, querying and data mining. All of which takes a considerable amount of time to process, resulting in a weak defense mechanism. Identity providers (IDP) conventionally do not have visibility into what users are actually doing in the cloud services during a session. They can only confirm that the user is who they say they are and provide them access, such as for a period of time.

### BRIEF SUMMARY OF THE DISCLOSURE

The present disclosure relates to systems and methods for tying activity of a user or group in a cloud service with an identity provider (IDP). This intelligence from the cloud service can be used to continuously authenticate a user or group as they are using the cloud service, thus confirming authentication beyond the initial identity (ID) determination or login process.

In an embodiment, the present disclosure includes a non-transitory computer-readable medium including instructions that, when executed, cause a processor to perform the steps of: receiving authentication from an Identity Provider (IDP) for a user and a user device; providing the user and the user device access to a cloud service based on the authentication; monitoring the access to the cloud service; and responsive to detecting anomalous behavior in the access, notifying the IDP for remediation. The remediation may include disabling an account of the user, disabling access by the user device, and requiring the user to change a password. The remediation may be performed while the user and the user device is accessing the cloud service. The anomalous behavior may be based on an Internet Protocol (IP) address and type of the user device changing more frequently than a baseline. The non-transitory computer-readable medium further include the steps of; gathering a baseline for the access over a period of time to develop a profile, wherein the detecting is based on activity in the access that falls outside of normalized behavior on a per human and device basis, in the profile.

In another embodiment, the present disclosure includes a server including: a processing device; a memory device configured to store a computer program having instructions that, when executed, cause a processing device to perform the steps of; receiving authentication from an Identity Provider (IDP) for a user and a user device; providing the user and the user device access to a cloud service based on the authentication; monitoring the access to the cloud service; and responsive to detecting anomalous behavior in the access, notifying the IDP for remediation. The remediation may include disabling an account of the user, disabling access by the user device, and requiring the user to change a password. The remediation may be performed while the user and the user device is accessing the cloud service. The anomalous behavior may be based on an Internet Protocol (IP) address and type of the user device changing more frequently than a baseline. The server further includes the steps of; gathering a baseline for the access over a period of time to develop a profile, wherein the detecting is based on activity in the access that falls outside of normalized behavior on a per human and device basis, in the profile.

In a further embodiment, the present disclosure includes a method including the steps of: receiving authentication from an Identity Provider (IDP) for a user and a user device; providing the user and the user device access to a cloud service based on the authentication; monitoring the access to the cloud service; and responsive to detecting anomalous behavior in the access, notifying the IDP for remediation. The remediation may include disabling an account of the user, disabling access by the user device, and requiring the user to change a password. The remediation may be performed while the user and the user device is accessing the cloud service. The anomalous behavior may be based on an Internet Protocol (IP) address and type of the user device changing more frequently than a baseline. The method further includes the steps of; gathering a baseline for the access over a period of time to develop a profile, wherein the detecting is based on activity in the access that falls outside of normalized behavior on a per human and device basis, in the profile.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a cloud-based system offering security as a service.

FIG. 2 is a network diagram of an example implementation of the cloud-based system.

FIG. 3 is a network diagram of the cloud-based system illustrating an application on the user devices with users configured to operate through the cloud-based system.

FIG. 4 is a block diagram of a server, which may be used in the cloud-based system, in other systems, or standalone.

FIG. 5 is a block diagram of a user device, which may be used with the cloud-based system or the like.

FIG. 6 is a network diagram of a Zero Trust Network Access (ZTNA) application utilizing the cloud-based system.

FIG. 7 is a network diagram of a cloud-based system offering Identity as a Service (IDaaS).

FIG. 8 is a diagram displaying the interaction and communication between Identity Providers and Cloud Services.

FIG. 9 is a flowchart of an example process of the Identity Intelligence of the present disclosure.

### DETAILED DESCRIPTION OF THE DISCLOSURE

Again, the present disclosure relates to systems and methods for tying activity of a user or group in a cloud service with an identity provider (IDP). This intelligence from the cloud service can be used to continuously authenticate a user or group as they are using the cloud service, thus confirming authentication beyond the initial identity (ID) determination or login process. By gathering a baseline for the access of users and groups, it is possible to detect when a user or user device shows anomalous behavior. Responsive to detecting anomalous behavior, the IDP can be notified, and remediation can be quickly initiated with the utilization of security measures such as access denial, account disabling, requiring a user to change a password, and/or other actions of the like. Such security actions may be preset in a playbook built for response to various security risks.

### Example Cloud-Based System Architecture

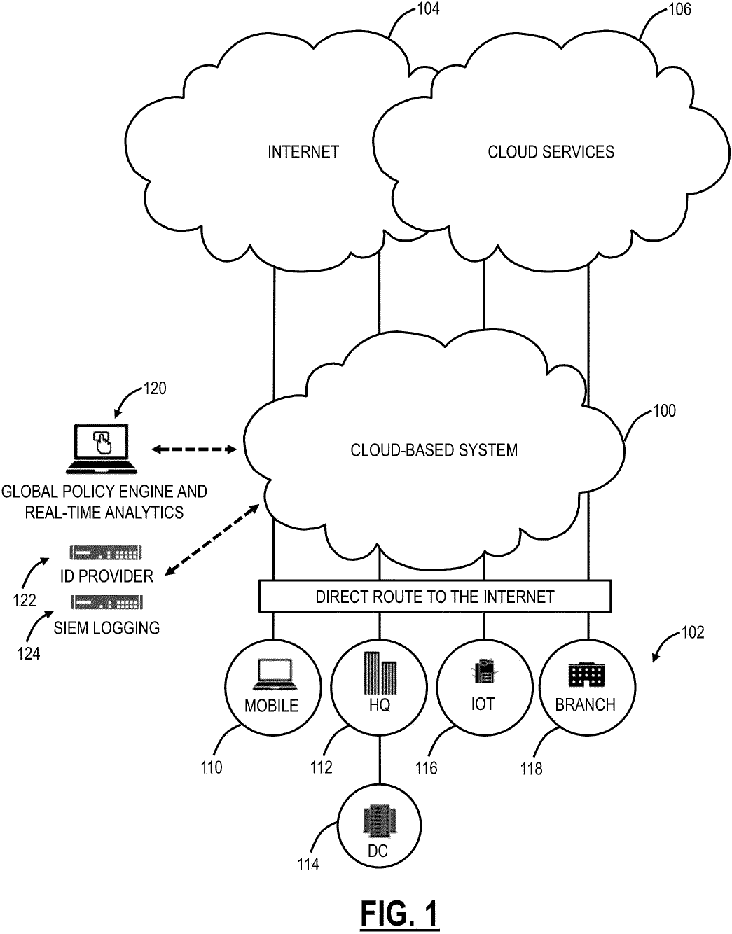

FIG. 1 is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via a Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

For illustration purposes, the users 102 of the cloud-based system 100 can include a mobile device 110, a headquarters (HQ) 112 which can include or connect to a data center (DC) 114, Internet of Things (IoT) devices 116, a branch office/remote location 118, etc., and each includes one or more user devices (an example user device 300 is illustrated in FIG. 5). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise’s network with resources in the data center 114. The mobile device 110 can be a so-called road warrior, i.e., users that are off-site, on-the-road, etc. Those skilled in the art will recognize a user 102 has to use a corresponding user device 300 for accessing the cloud-based system 100 and the like, and the description herein may use the user 102 and/or the user device 300 interchangeably.

Further, the cloud-based system 100 can be multi-tenant, with each tenant having its own users 102 and configuration, policy, rules, etc. One advantage of the multi-tenancy and a large volume of users is the zero-day protection in that a new vulnerability can be detected and then instantly remediated across the entire cloud-based system 100. The same applies to policy, rule, configuration, etc. changes - they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 116) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116, when not at one of the locations 112, 114, 118 can use a local application that forwards traffic, a proxy such as via a Proxy Auto-Config (PAC) file, and the like. An application of the local application is the application 350 described in detail herein as a connector application. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

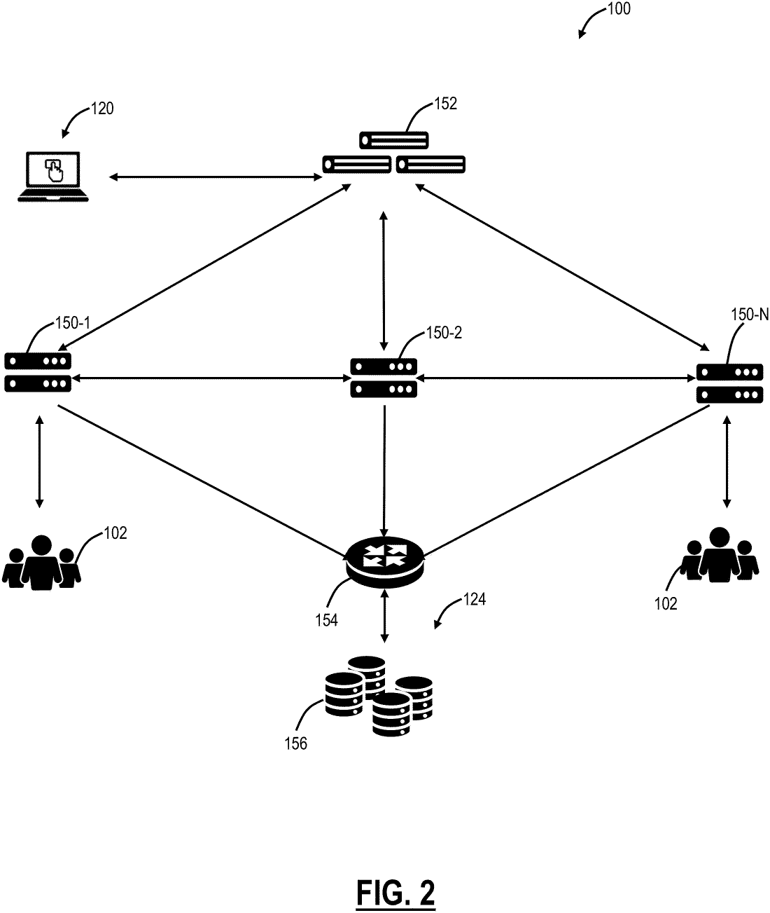

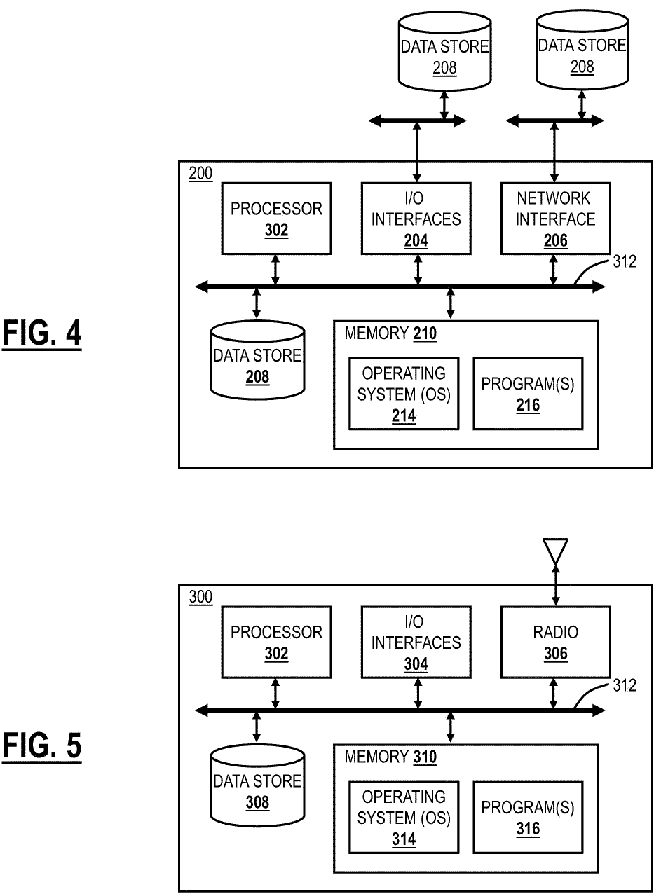

FIG. 2 is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA) 152. The nodes 150 and the central authority 152, while described as nodes, can include one or more servers, including physical servers, virtual machines (VM) executed on physical hardware, etc. An example of a server is illustrated in FIG. 4. The cloud-based system 100 further includes a log router 154 that connects to a storage cluster 156 for supporting log maintenance from the enforcement nodes 150. The central authority 152 provide centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150.

Of note, the cloud-based system 100 is an external system meaning it is separate from tenant’s private networks (enterprise networks) as well as from networks associated with the devices 110, 116, and locations 112, 118. Also, of note, the present disclosure describes a private enforcement node 150P that is both part of the cloud-based system 100 and part of a private network. Further, of note, the enforcement node described herein may simply be referred to as a node or cloud node. Also, the terminology enforcement node 150 is used in the context of the cloud-based system 100 providing cloud-based security. In the context of secure, private application access, the enforcement node 150 can also be referred to as a service edge or service edge node. Also, a service edge node 150 can be a public service edge node (part of the cloud-based system 100) separate from an enterprise network or a private service edge node (still part of the cloud-based system 100) but hosted either within an enterprise network, in a data center 114, in a branch office 118, etc. Further, the term nodes as used herein with respect to the cloud-based system 100 (including enforcement nodes, service edge nodes, etc.) can be one or more servers, including physical servers, virtual machines (VM) executed on physical hardware, etc., as described above.

The enforcement nodes 150 are full-featured secure internet gateways that provide integrated internet security. They inspect all web traffic bi-directionally for malware and enforce security, compliance, and firewall policies, as described herein, as well as various additional functionality. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure Transport Layer Security (TLS) connections to the log routers 154 that direct the logs to the storage cluster 156, hosted in the appropriate geographical region, for each organization. In an embodiment, all data destined for or received from the Internet is processed through one of the enforcement nodes 150. In another embodiment, specific data specified by each tenant, e.g., only email, only executable files, etc., is processed through one of the enforcement nodes 150.

Each of the enforcement nodes 150 may generate a decision vector D = [d1, d2, ... , dn] for a content item of one or more parts C = [c1, c2, ... , cm]. Each decision vector may identify a threat classification, e.g., clean, spyware, malware, undesirable content, innocuous, spam email, unknown, etc. For example, the output of each element of the decision vector D may be based on the output of one or more data inspection engines. In an embodiment, the threat classification may be reduced to a subset of categories, e.g., violating, non-violating, neutral, unknown. Based on the subset classification, the enforcement node 150 may allow the distribution of the content item, preclude distribution of the content item, allow distribution of the content item after a cleaning process, or perform threat detection on the content item. In an embodiment, the actions taken by one of the enforcement nodes 150 may be determinative on the threat classification of the content item and on a security policy of the tenant to which the content item is being sent from or from which the content item is being requested by. A content item is violating if, for any part C=[c1, c2, ... , cm] of the content item, at any of the enforcement nodes 150, any one of the data inspection engines generates an output that results in a classification of “violating.”

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

The policy can be tenant-specific and can include access privileges for users, websites and/or content that is disallowed, restricted domains, DLP dictionaries, etc. Once downloaded, a tenant’s policy is cached until a policy change is made in the management system 120. The policy can be tenant-specific and can include access privileges for users, websites and/or content that is disallowed, restricted domains, DLP dictionaries, etc. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company’s on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). Also, there can be multiple different cloud-based systems 100, including ones with different architectures and multiple cloud services. The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### User Device Application for Traffic Forwarding and Monitoring

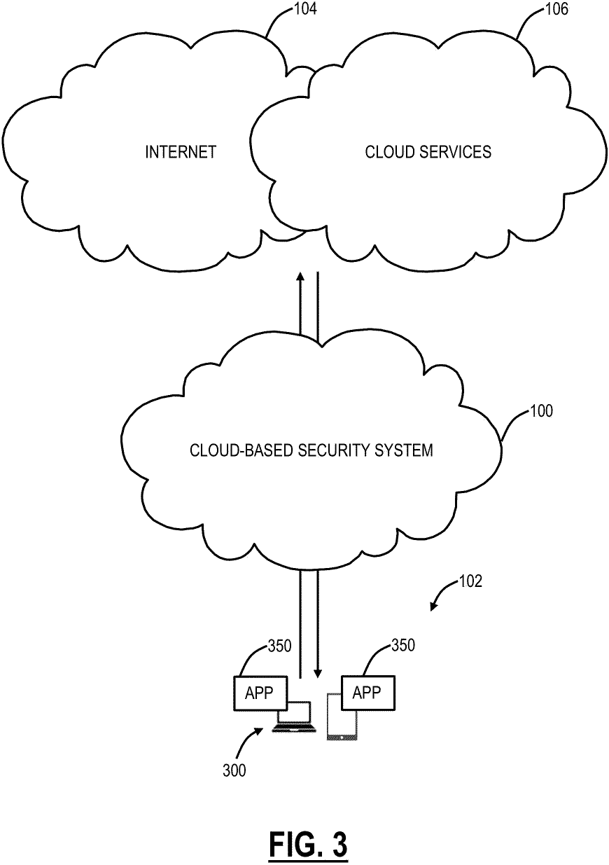

FIG. 3 is a network diagram of the cloud-based system 100 illustrating an application 350 on user devices 300 with users 102 configured to operate through the cloud-based system 100. Different types of user devices 300 are proliferating, including Bring Your Own Device (BYOD) as well as IT-managed devices. The conventional approach for a user device 300 to operate with the cloud-based system 100 as well as for accessing enterprise resources includes complex policies, VPNs, poor user experience, etc. The application 350 can automatically forward user traffic with the cloud-based system 100 as well as ensuring that security and access policies are enforced, regardless of device, location, operating system, or application. The application 350 automatically determines if a user 102 is looking to access the open Internet 104, a SaaS app, or an internal app running in public, private, or the datacenter and routes mobile traffic through the cloud-based system 100. The application 350 can support various cloud services, including ZIA, ZPA, ZDX, etc., allowing the best in class security with zero trust access to internal apps. As described herein, the application 350 can also be referred to as a connector application.

The application 350 is configured to auto-route traffic for seamless user experience. This can be protocol as well as application-specific, and the application 350 can route traffic with a nearest or best fit enforcement node 150. Further, the application 350 can detect trusted networks, allowed applications, etc. and support secure network access. The application 350 can also support the enrollment of the user device 300 prior to accessing applications. The application 350 can uniquely detect the users 102 based on fingerprinting the user device 300, using criteria like device model, platform, operating system, etc. The application 350 can support Mobile Device Management (MDM) functions, allowing IT personnel to deploy and manage the user devices 300 seamlessly. This can also include the automatic installation of client and SSL certificates during enrollment. Finally, the application 350 provides visibility into device and app usage of the user 102 of the user device 300.

The application 350 supports a secure, lightweight tunnel between the user device 300 and the cloud-based system 100. For example, the lightweight tunnel can be HTTP-based. With the application 350, there is no requirement for PAC files, an IPsec VPN, authentication cookies, or user 102 setup.

### Example Server Architecture

FIG. 4 is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Example User Device Architecture

FIG. 5 is a block diagram of a user device 300, which may be used with the cloud-based system 100 or the like. Specifically, the user device 300 can form a device used by one of the users 102, and this may include common devices such as laptops, smartphones, tablets, netbooks, personal digital assistants, MP3 players, cell phones, e-book readers, IoT devices, servers, desktops, printers, televisions, streaming media devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 5 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### Zero Trust Network Access Using the Cloud-Based System

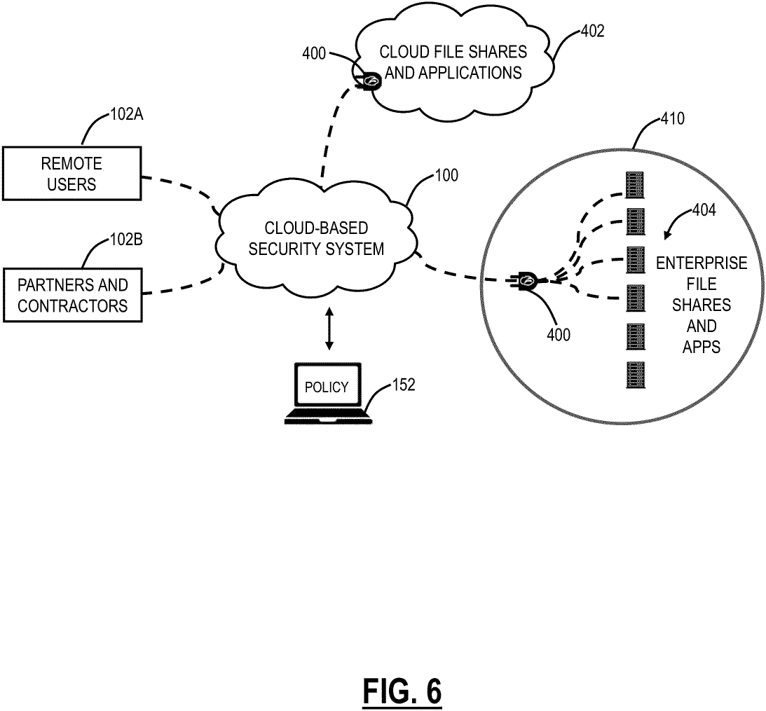

FIG. 6 is a network diagram of a Zero Trust Network Access (ZTNA) application utilizing the cloud-based system 100. For ZTNA, the cloud-based system 100 can dynamically create a connection through a secure tunnel between an endpoint (e.g., users 102A, 102B) that are remote and an on-premises connector 400 that is either located in cloud file shares and applications 402 and/or in an enterprise network 410 that includes enterprise file shares and applications 404. The connection between the cloud-based system 100 and on-premises connector 400 is dynamic, on-demand, and orchestrated by the cloud-based system 100. A key feature is its security at the edge - there is no need to punch any holes in the existing on-premises firewall. The connector 400 inside the enterprise (on-premises) “dials out” and connects to the cloud-based system 100 as if too were an endpoint. This on-demand dial-out capability and tunneling authenticated traffic back to the enterprise is a key differentiator for ZTNA. Also, this functionality can be implemented in part by the application 350 on the user device 300. Also, the applications 402, 404 can include B2B applications. Note, the difference between the applications 402, 404 is the applications 402 are hosted in the cloud, whereas the applications 404 are hosted on the enterprise network 410. The B2B service described herein contemplates use with either or both of the applications 402, 404.

The paradigm of virtual private access systems and methods is to give users network access to get to an application and/or file share, not to the entire network. If a user is not authorized to get the application, the user should not be able even to see that it exists, much less access it. The virtual private access systems and methods provide an approach to deliver secure access by decoupling applications 402, 404 from the network, instead of providing access with a connector 400, in front of the applications 402, 404, an application on the user device 300, a central authority 152 to push policy, and the cloud-based system 100 to stitch the applications 402, 404 and the software connectors 400 together, on a per-user, per-application basis.

With the virtual private access, users can only see the specific applications 402, 404 allowed by the central authority 152. Everything else is “invisible” or “dark” to them. Because the virtual private access separates the application from the network, the physical location of the application 402, 404 becomes irrelevant - if applications 402, 404 are located in more than one place, the user is automatically directed to the instance that will give them the best performance. The virtual private access also dramatically reduces configuration complexity, such as policies/firewalls in the data centers. Enterprises can, for example, move applications to Amazon Web Services or Microsoft Azure, and take advantage of the elasticity of the cloud, making private, internal applications behave just like the marketing leading enterprise applications. Advantageously, there is no hardware to buy or deploy because the virtual private access is a service offering to end-users and enterprises.

### Identity as a Service (IDaaS)

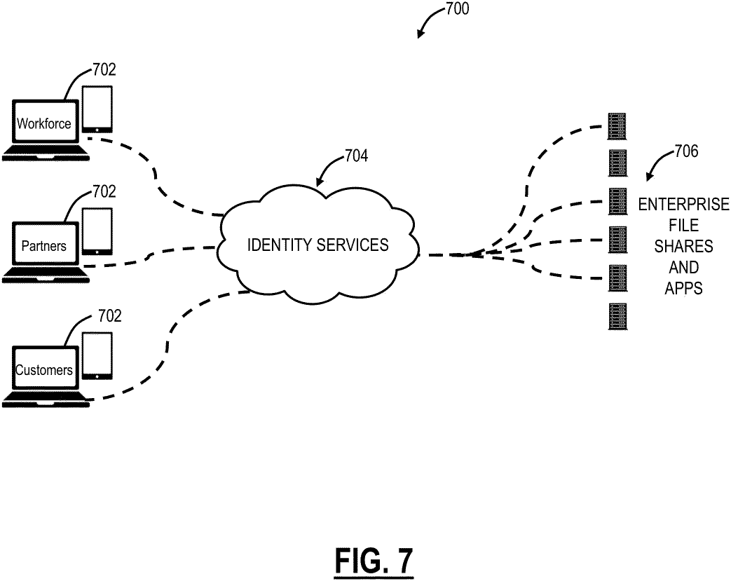

FIG. 7 is a network diagram of a cloud-based system 700 offering Identity as a Service (IDaaS). The goal of identity services 704 such as IDaaS is to authenticate and determine the identity of users 702 as to provide each user 702 with the correct access to enterprise files, software, applications and other resources 706 that specific users 702 are authorized to access. The users 702 may be any member of the workforce, a partner of an enterprise, customers, and any other user that is granted access to enterprise files and/or apps in any capacity. It also involves collecting intelligence such as logging events and generating reports on users 702, including when and where a user 702 accessed a system and what information they were able to access.

Identity governance and administration (IGA) is a core aspect of IDaaS and encompasses all of the necessary aspects of managing a plurality of user identities. This may include password management, permits, provisioning, and user role-based authorization management, and the like. An IDaaS service may incorporate a plurality of means of identification management. These means may include features such as multi-factor authentication (MFA) provided by way of biometrics, passwords, or digital access cards maintained across a variety of access points and devices.

One of many prominent applications for IDaaS is single sign-on (SSO). SSO allows users to sign in only one time within the network perimeter. With this single sign-in, users are able to obtain access to a plurality of different parts of an enterprises resources that the user has been authorized to gain access to. This keeps a user from needing to continually sign into different programs or resources within a network, allowing users to switch between applications in the system without having to enter credentials again.

Multi-factor Authentication (MFA) dramatically increases security levels with each added authentication step. The added authentication steps may include biometrics, SMS OTP, passwords, hardware tokens, and the like. Each added authentication step increases security but also decreases the user experience, thus, two-factor authentication is most commonly used. The different authentication request may be adaptive as to counteract fraud and include real-time risk management.

Once again, the Identity as a Service (IDaaS) market has attracted more and more interest, and many large businesses and enterprises are now quickly taking advantage of IDaaS due to low upfront investment, rapid deployment, simplified operation and native-integration with existing cloud workloads. This shift along with a landscape of upwardly-mobile consumers, remote workers, Bring your own device (BYOD) policies and a globally geo-dispersed workforce, has continued to stretch many organizations’ attack surfaces even wider than before. With this increased attack surface, security engineers are tasked with utilizing built-in anomalous detection capability from IDaaS vendors (Azure Security Center, Okta Anomaly Detection etc) or pay additional fees to implement. If misconfigured and tuned improperly, it is possible for threat actors to evade IDaaS detection controls altogether or for false-positives to appear. However, even when configured properly, there is a noticeable gap in latency of notification, contextual awareness and Signal-to-Noise ratio (SNR) of logs is often too low, noisy, and hard to decipher actionable signals without considerable indexing, querying and data mining. All of which takes a considerable amount of time to process, resulting in a weak defense mechanism. Identity providers (IDP) conventionally do not have visibility into what users are actually doing in the cloud services during a session. They can only confirm that the user is who they say they are and provide them access, such as for a period of time.

### Identity Intelligence

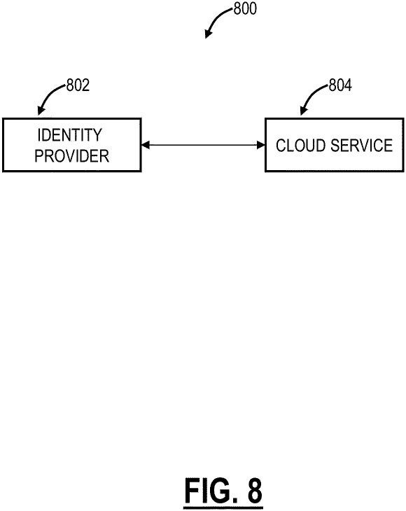

The present disclosure provides a way to tie activity in a cloud service 804 with an identity provider (IDP) 802 as shown in the diagram 800 in FIG. 8. Intelligence gathered from the cloud service can be used to constantly authenticate users as they are actively accessing the service, allowing for real time action being taken on security threats. Various existing solutions are Security as a Service (SaaS) based only, are not developer friendly. Many existing solutions are not cloud-native while offering a limited number of notification options as well as being increasingly costly. These options are not made to support an internal workforce as well as fulfill demands from customers, while also not being a bolt-on security solution in contrast to the present disclosure.

The core concept and architecture around the present disclosure and the present embodiment, Zscaler Identity Intelligence (ZII), is geared at working in conjunction with existing IDaaS security controls, if such IDaaS security controls are in place, or to fill the gap when none are used. The present embodiment can be construed as a bolt-on solution which makes existing IDaaS solutions more secure, smarter (contextually aware), and able to share critical information directly with developers and security engineers more quickly and accurately. ZII does this by narrowing the scope for which it captures and analyzes data, targeting sign-in activity from humans and devices, and creating a dynamic risk-based profile. Therefore, gathering baseline over a period of time, then alerting on data skew/anomalies that fall outside of normalized behavior on a per human and device basis.

Coupled with several ‘Contextual Connectors’, such as Zscaler, Amazon Web Services, Google Cloud Platform, Microsoft Azure, Aviatrix, Haveibeenpwnd, SpyCloud, Crowdstrike, SFDC, Snowflake, Office 365, Google Workspace, or the like and generally referred to as cloud services via a cloud-based system 100. Such contextual connectors enrich findings with context and create graphs of entitlement/access for users across clouds. Essentially 3rd party Cloud integrations that help enrich User and Device chain of custody, what a user has access to. Playbooks and auto-remediation steps can be created across clouds to proactively prevent account takeover (ATO), brute force, password spray, and potential exfil of enterprise data.

Since ZII is focused on this specific area of detection and anomalous user activity, accurate and enriched signals can then be sent directly to security engineers and developers to take action as needed based on the anomalous activity.

### Example

An existing IDaaS service such as Azure Security Center or the like flags sign-in activity as a high risk due to multiple invalid password attempts. This being flagged due to anomalous activity, for example, three invalid password attempts within the last thirty minutes. Additionally, Zscaler Identity Intelligence (ZII) detects an anomalous user location. Identifying user IP and device changed more frequently than a baseline frequency set initially by a security team or gathered by the system over a period of time. Based on additional findings, the situation appears to be high risk sign in activity. ZII queries information on the user such as what the user has access to (contextual connectors) via the graphical database. Since the anomalous activity meets the criticality set initially by the internal security team, and a playbook has been created for this, Zscaler Identity Intelligence identifies that the User is a privileged administrator in Amazon Web Services (has an IAM User account) as well as an Aviatrix VPN. The playbook runs, and the user’s AWS IAM User account is disabled and access to Aviatrix VPN is set to Inactive as well, using each of the Contextual Connector’s APIs. Findings of signal, along with custodial chain of custody of actions taken for User is immediately pushed to a Slack or MS Teams channel, or whatever notification option is setup and prioritized within the webapp. Along with recommended steps for investigation, as well as decisioning on if any further steps should be taken by security. Additional actions can be added by the security team or removed depending on internal policy.

Again, the present disclosure provides a way to tie activity in a cloud service with an identity provider (IDP). Intelligence gathered from the cloud service can be used to constantly authenticate users as they are actively accessing the service, allowing for real time action being taken on security threats. This is achieved through connectors such as IDaaS connectors, generally a pre-made API integration to third parties which are largely Identity Providers (IDP) such as Microsoft Azure AD, Okta, PingIdentity, Auth0, and the like. Contextual Connectors such as Zscaler, Amazon Web Services, Google Cloud Platform, Microsoft Azure, Aviatrix, Haveibeenpwnd, SpyCloud, Crowdstrike, SFDC, Snowflake, Office 365, Google Workspace, or the like enrich findings with context and creates a graph of entitlements/access across Clouds, generally referred to as cloud services via a cloud-based system 100. A dashboard may show the various connections to IDaaS services, risk and attack surfaces, recent signals, and recent notifications. The signal notifications coming by way of slack workspace, MS Teams, SIEM integration, Email, PagerDuty, and the like. In some embodiments the playbook of which the system follows may be a drag and drop builder of what to do if a high-risk activity or anomalous behavior is found.

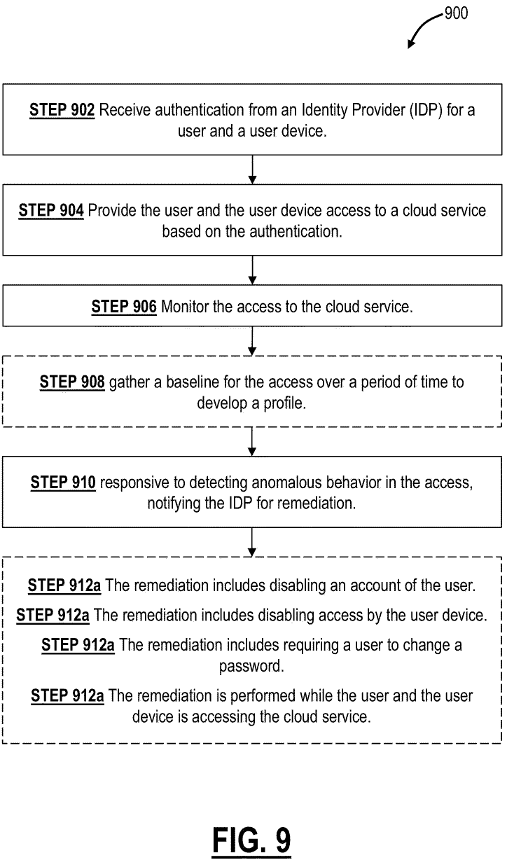

FIG. 9 is a flow diagram 900 showing a description of steps that the present disclosure may follow. Initially, the system receives authentication from an identity provider (IDP) for a user or user device to gain access to enterprise files, apps, cloud services, or the like. The user and/or user device is given access to a cloud service based on the authentication. Different users, user groups, or predetermined authentication groups may be given access to various elements of the enterprise services, files, and the like. The access to the cloud service is monitored continuously to observe user behavior and trends. Optionally, a baseline may be gathered for the access over a period of time to develop a profile, thus creating a normal user behavior intelligence allowing the system to identify abnormal behavior or actions. Responsive to detecting ambiguous behavior in the access, the system will notify the IDP for remediation, such remediation may include disabling an account of the user, disabling access by the user, requiring the user to change a password, and other security measures of the like. The remediation may be performed while the user and the user device is accessing the cloud service.

### Conclusion

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc., described herein can be used in any and all combinations with each other.

What is claimed is:

1. A non-transitory computer-readable medium comprising instructions that, when executed, cause a processor to perform the steps of:
receiving authentication from an Identity Provider (IDP) for a user and a user device;
providing the user and the user device access to a cloud service based on the authentication;
monitoring the access to the cloud service; and
responsive to detecting anomalous behavior in the access, notifying the IDP for remediation.

2. The non-transitory computer-readable medium of claim 1, wherein the remediation includes disabling an account of the user.

3. The non-transitory computer-readable medium of claim 1, wherein the remediation includes disabling access by the user device.

4. The non-transitory computer-readable medium of claim 1, wherein the remediation includes requiring the user to change a password.

5. The non-transitory computer-readable medium of claim 1, wherein the remediation is performed while the user and the user device is accessing the cloud service.

6. The non-transitory computer-readable medium of claim 1, wherein the anomalous behavior is based on an Internet Protocol (IP) address and type of the user device changing more frequently than a baseline.

7. The non-transitory computer-readable medium of claim 1, further comprising the steps of;
gathering a baseline for the access over a period of time to develop a profile, wherein the detecting is based on activity in the access that falls outside of normalized behavior on a per human and device basis, in the profile.

8. A server comprising:
a processing device;
a memory device configured to store a computer program having instructions that, when executed, cause a processing device to perform the steps of;
receiving authentication from an Identity Provider (IDP) for a user and a user device;
providing the user and the user device access to a cloud service based on the authentication;
monitoring the access to the cloud service; and
responsive to detecting anomalous behavior in the access, notifying the IDP for remediation.

9. The server of claim 8, wherein the remediation includes disabling an account of the user.

10. The server of claim 8, wherein the remediation includes disabling access by the user device.

11. The server of claim 8, wherein the remediation includes requiring the user to change a password.

12. The server of claim 8, wherein the remediation is performed while the user and the user device is accessing the cloud service.

13. The server of claim 8, wherein the anomalous behavior is based on an Internet Protocol (IP) address and type of the user device changing more frequently than a baseline.

14. The server of claim 8, further comprising gathering a baseline for the access over a period of time to develop a profile, wherein the detecting is based on activity in the access that falls outside of normalized behavior on a per human and device basis, in the profile.

15. A method comprising
receiving authentication from an Identity Provider (IDP) for a user and a user device;
providing the user and the user device access to a cloud service based on the authentication;
monitoring the access to the cloud service; and
responsive to detecting anomalous behavior in the access, notifying the IDP for remediation.

16. The method of claim 15, wherein the remediation includes disabling an account of the user.

17. The method of claim 15, wherein the remediation includes disabling access by the user device.

18. The method of claim 15, wherein the remediation includes requiring the user to change a password.

19. The method of claim 15, wherein the remediation is performed while the user and the user device is accessing the cloud service.

20. The method of claim 15, further comprising;
gathering a baseline for the access over a period of time to develop a profile, wherein the detecting is based on activity in the access that falls outside of normalized behavior on a per human and device basis, in the profile.
